(19) United States
(12) Patent Application Publication
(10) Pub. No.: US 2026/0144399 A1
(43) Pub. Date: May 28, 2026

(54) COFFEE MAKING SYSTEM AND METHOD

(71) Applicant: THE BOEING COMPANY, Arlington, VA (US)

(72) Inventor: Thippeswamy Hiremath, Bangalore (IN)

(73) Assignee: THE BOEING COMPANY, Arlington, VA (US)

(21) Appl. No.: 18/956,762

(22) Filed: Nov. 22, 2024

(51) Int. Cl. A47J 31/44; A47J 31/06

(52) U.S. Cl. CPC A47J 31/4403; A47J 31/0668

(57) ABSTRACT

A coffee making system includes a housing. A base is coupled to the housing. An internal chamber is defined between the housing and the base. The internal chamber is configured to receive a carafe. The coffee making system also includes a carafe restraining plate, and a shower head assembly coupled to the carafe restraining plate. A lever is operatively coupled to the carafe restraining plate. Movement of the lever causes synchronous motion of the carafe restraining plate and the shower head assembly.

### FIELD OF THE DISCLOSURE

Examples of the present disclosure generally relate to a coffee making system and method, which can be used within a galley of a vehicle.

### BACKGROUND OF THE DISCLOSURE

Commercial aircraft include an internal cabin having one or more gallies. A galley provides a space where beverages and food items are stored. Flight attendants retrieve such items from the galley for distribution to passengers during a flight. A coffee maker is often disposed within a galley.

A typical coffee maker for use within an aircraft includes a primary locking mechanism, a secondary restraint device, and an additional mechanism for locking a pillow pack holder in place during brewing. In particular, two separate mechanisms are used to lock the pillow pack holder and a carafe in place during brewing. The primary locking mechanism assists in locking holding the carafe in place, and the secondary restraint device ensures that the carafe is not displaced during aircraft movement, such as during take-off and landing. In general, known coffee makers used in commercial aircraft typically have numerous complex mechanical linkages, metal parts, stamped parts, fasteners, and the like, which can degrade and malfunction over time.

### SUMMARY OF THE DISCLOSURE

A need exists for an improved coffee maker, which can be used within an internal cabin of a vehicle, such as a commercial aircraft. Further, a need exists for an efficient, effective, and simple system and method for locking a pillow pack holder and a carafe in position during a brewing process.

With those needs in mind, certain examples of the present disclosure provide a coffee making system including a housing. A base is coupled to the housing. An an internal chamber is defined between the housing and the base. The internal chamber is configured to receive a carafe. The coffee making system also includes a carafe restraining plate, and a shower head assembly coupled to the carafe restraining plate. A lever is operatively coupled to the carafe restraining plate. Movement of the lever causes synchronous motion of the carafe restraining plate and the shower head assembly.

In at least one example, a first cartridge bracket and a second cartridge bracket are secured to the housing. The first cartridge bracket and the second cartridge bracket are configured to removably retain a pillow pack holding cartridge. As a further example, each of the first cartridge bracket and the second cartridge bracket includes a reciprocal groove configured to receive and retain a portion of the pillow pack holding cartridge. In at least one example, the first cartridge bracket and the second cartridge bracket are configured to fix the pillow pack holding cartridge in relation to the housing during the synchronous motion of the carafe restraining plate and the shower head assembly.

In at least one example, an axle having one or more bearings engage the carafe restraining plate. The axle is coupled to the lever. The lever can include a first arm, a handle extending from the first arm, and a second arm connected to the first arm. The second arm operatively connects to the axle.

In at least one example, the carafe restraining plate includes one or more indentations configured to receive the one or more bearings to lock the carafe restraining plate and the shower head assembly in place.

The carafe restraining plate can include a liquid basin having a drain, and/or a sensor recess configured to retain a level sensor.

In at least one example, one or more guide rods couple the carafe restraining plate to the shower head assembly. One or more springs can be coupled to one or more of the one or more guide rods.

In at least one example, the shower head assembly includes a main plate. A drain is formed through the main plate. An O-ring is secured to the main plate. A head plate is secured to the main plate. A gasket is secured to the main plate.

Certain examples of the present disclosure provide a method including moving the lever; and causing, by the moving of the lever, synchronous motion of the carafe restraining plate and the shower head assembly.

### BRIEF DESCRIPTION OF THE DRAWINGS

FIG. 1 illustrates a perspective front view of a coffee making system, according to example of the present disclosure.

FIG. 2 illustrates a perspective front view of the coffee making system retaining a pillow pack holding cartridge, according to an example of the present disclosure.

FIG. 3 illustrates an isometric interior view of the first cartridge bracket and the second cartridge bracket, according to an example of the present disclosure.

FIG. 4 illustrates an isometric front exploded view of an axle in relation to the first cartridge bracket and the second cartridge bracket, according to an example of the present disclosure.

FIG. 5 illustrates an isometric top view of a carafe restraining plate, according to an example of the present disclosure.

FIG. 6 illustrates an isometric front view of the carafe restraining plate coupled to the first cartridge bracket and the second cartridge bracket, according to an example of the present disclosure.

FIG. 7 illustrates an isometric front lateral view of a lever coupled to the carafe restraining plate, according to an example of the present disclosure.

FIG. 8 illustrates an isometric bottom exploded view of a shower head assembly, according to an example of the present disclosure.

FIG. 9 illustrates an isometric front view of the shower head assembly disconnected from guide rods, according to an example of the present disclosure.

FIG. 10 illustrates a perspective front view of a system for synchronizing a shower head assembly with a carafe restraining plate, according to an example of the present disclosure.

FIG. 11 illustrates a perspective side view of the system of FIG. 10.

FIG. 12 illustrates a perspective front view of the coffee making system supporting a carafe in an unlocked position, according to an example of the present disclosure.

FIG. 13 illustrates a perspective front view of the coffee making system supporting the carafe in a locked position, according to an example of the present disclosure.

FIG. 14 illustrates a perspective front view of an aircraft, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

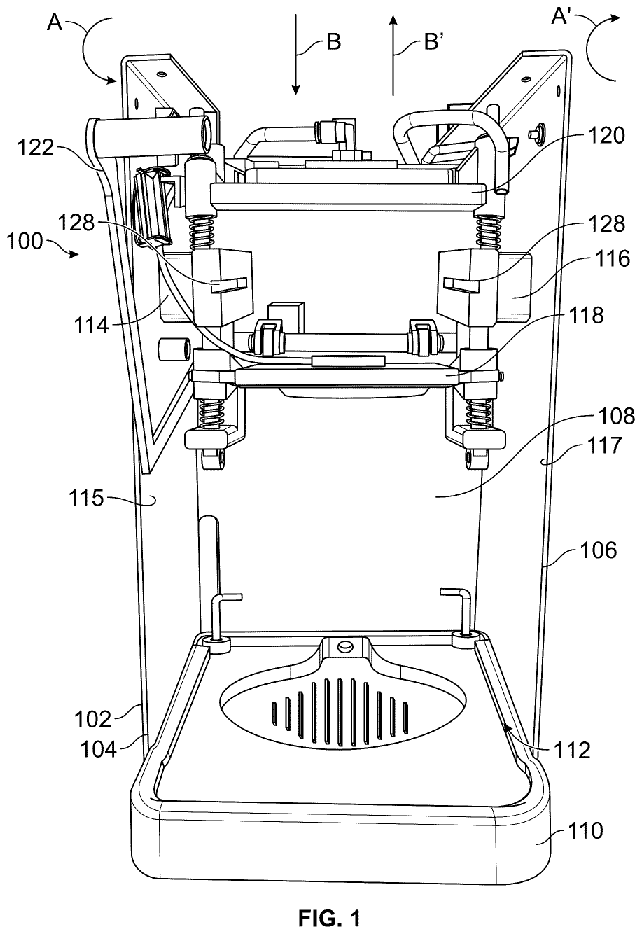

FIG. 1 illustrates a perspective front view of a coffee making system 100, according to example of the present disclosure. The coffee making system 100 includes a housing 102 including side walls 104 and 106 connected to a rear wall 108. A front of the coffee making system 100 is open to receive a carafe (not show in FIG. 1). The coffee making system 100 also includes a base 110 configured to support the carafe within an internal chamber 112 defined between the side walls 104, 106, the rear wall 108, and the base 110.

A first cartridge bracket 114 is secured to an interior surface 115 of the side wall 104 (such as through one or more fasteners, adhesives, and/or the like), and a second cartridge bracket 116 is secured to an interior surface 117 of the side wall 106 (such as through one or more fasteners, adhesives, and/or the like). The first cartridge bracket 114 and the second cartridge bracket 116 mirror one another, and are configured to retain a pillow pack holding cartridge (not shown in FIG. 1) within the internal chamber 112 above the carafe supported on the base 110.

A carafe restraining plate 118 is moveably secured to the first cartridge bracket 114 and the second cartridge bracket 116. Further, a shower head assembly 120 is also moveably secured to the first cartridge bracket 114 and the second cartridge bracket 116, such as through one or more guide rods. A lever 122 is coupled to the carafe restraining plate 118, which is, in turn, coupled to the shower head assembly 120, such as through the one or more guide rods.

In operation, the lever 122 is configured to be pivoted downwardly in the direction of arc A. In response to the movement of the lever 122, the carafe restraining plate 118 moves downwardly in the direction of arrow B over a top of the carafe to lock the carafe in position on the base 110. In response to the movement of the carafe restraining plate 118, the shower head assembly 120 moves downwardly in the direction of arrow B in unison with the carafe restraining plate 118. In this manner, the lever 122, which is coupled to the carafe restraining plate 118, provides synchronous motion of the carafe restraining plate 118 and the shower head assembly 120.

In order to remove the carafe restraining plate 118 from the carafe, the lever 122 is upwardly pivoted in the direction of arc A′, which causes the carafe restraining plate 118 to move upwardly in the direction of arrow B′ and unseat from the top of the carafe. In response, the shower head assembly 120 also moves upwardly in the direction of arrow B′, as the shower head assembly 120 is synchronously linked to the carafe restraining plate 118.

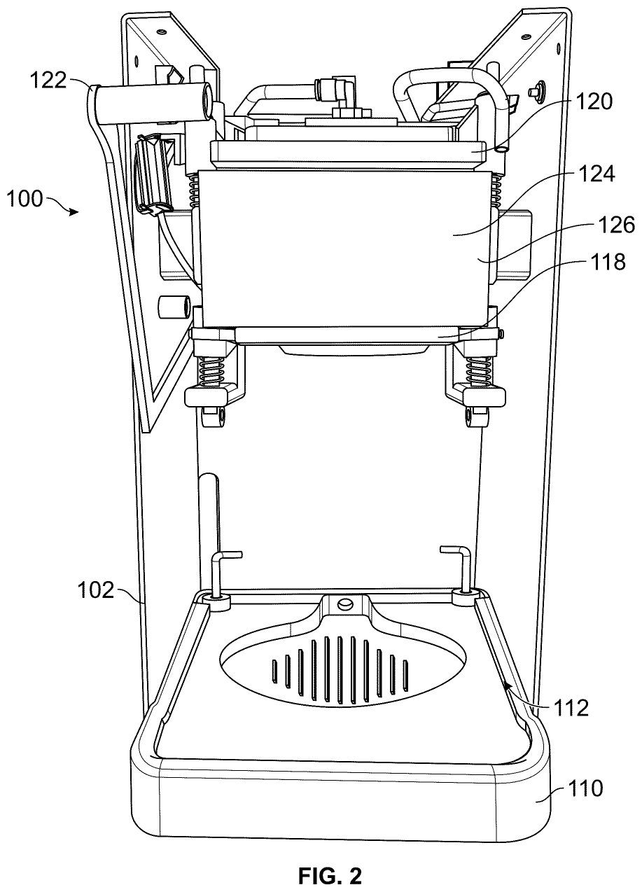

FIG. 2 illustrates a perspective front view of the coffee making system 100 retaining a pillow pack holding cartridge 124, according to an example of the present disclosure. The pillow pack holding cartridge 124 includes a holding block 126 and side rails (not shown in FIG. 2). The holding block 126 is configured to retain a pillow pack, such as a unitary filter pouch retaining coffee grounds, for example.

Referring to FIGS. 1 and 2, the pillow pack holding cartridge 124 is inserted into the internal chamber 112 such that respective side rails of the pillow pack holding cartridge 124 are slid into reciprocal grooves 128 of the first cartridge bracket 114 and the second cartridge bracket 116, respectively, thereby retaining the pillow pack holding cartridge 124 in place above base 110. The first cartridge bracket 114 and the second cartridge bracket 116 cooperate to lock the pillow pack holding cartridge 124 in place. The pillow pack holding cartridge 124 is removably secured within the internal chamber 112 by the first cartridge bracket 114 and the second cartridge bracket 116. During the synchronous motion of the carafe restraining plate 118 and the shower head assembly 120 by the lever 122, the pillow pack holding cartridge 124 remains fixed in place within the internal chamber 112 by the first cartridge bracket 114 and the second cartridge bracket 116. That is, the lever 122 does not move the first cartridge bracket 114, the second cartridge bracket 116, or the pillow pack holding cartridge 124. The lever 122 operatively coupled to the carafe restraining plate 118 and the shower head assembly 120 provides an assembly that is configured to synchronously move the carafe restraining plate 118 and the shower head assembly 120 in unison, while the pillow pack holding cartridge 124 remains fixed and locked in position.

As described herein, the coffee making system 100 includes the housing 102. The base 110 coupled to the housing 102. The internal chamber 112 is defined between the housing 102 and the base 110. The internal chamber 112 is configured to receive a carafe. The coffee making system 100 further includes the carafe restraining plate 118. The shower head assembly 120 is coupled to the carafe restraining plate 118. The lever 122 is operatively coupled to the carafe restraining plate 118. Movement of the lever 122 causes synchronous motion of the carafe restraining plate 118 and the shower head assembly 120. In at least one example, the coffee making system 100 further includes the first cartridge bracket 114 and the second cartridge bracket 116, each of which is secured to the housing. The first cartridge bracket 114 and the second cartridge bracket 116 are configured to securely retain the pillow pack holding cartridge 124.

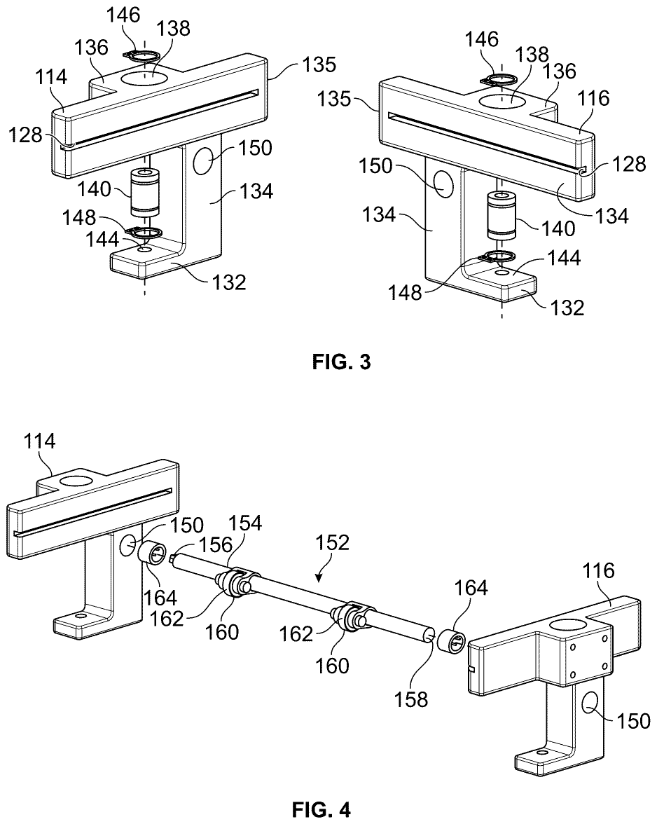

FIG. 3 illustrates an isometric interior view of the first cartridge bracket 114 and the second cartridge bracket 116, according to an example of the present disclosure. Each of the first cartridge bracket 114 and the second cartridge bracket 116 includes a base tab 132. A column 134 upwardly extends from an end of the base tab 132. A retaining beam 135 extends inwardly from a top of the column 134. The retaining beam 135 includes the groove 128, which is configured to receive and retain a side rail of the pillow pack holding cartridge 124 (shown in FIG. 2). A protuberance 136 outwardly extends from the retaining beam 135. A passage 138 extends through the protuberance 136. The passage 138 is axially aligned with a bearing 140 (such as roller bearing), which can be coupled to a guide rod. The bearing 140 can be a linear ball bearing, for example. One or more retaining rings 144 and/or 146 can also be disposed within or proximate to the passages 138. An axle passage 150 is formed through each of the first cartridge bracket 114 and the second cartridge bracket 116. Referring to FIGS. 1-3, the axle passages 150 are coaxial with one another.

FIG. 4 illustrates an isometric front exploded view of an axle 152 in relation to the first cartridge bracket 114 and the second cartridge bracket 116, according to an example of the present disclosure. The axle 152 includes a rod 154 having a first end 156 and an opposite second end 158. Bearings 160 forwardly extend from the rod 154. The bearings 160 includes arcuate ends 162 distally disposed from the rod 154. Roller bearings 164 are configured to be retained within the axle passages 150, and rotatably retain the ends 156 and 158 therein. The axle 152 can include more or fewer bearings 160 than shown. For example, the axle 152 may include only one bearing 160. As another example, the axle 152 can include three bearings 160.

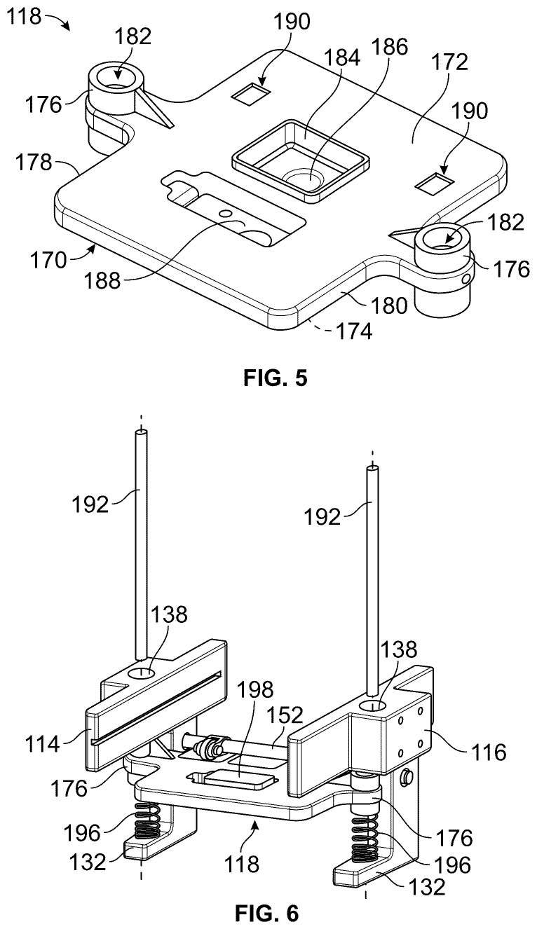

FIG. 5 illustrates an isometric top view of the carafe restraining plate 118, according to an example of the present disclosure. The carafe restraining plate 118 includes a main panel 170 including a top surface 172 opposite form a bottom surface 174. Guide cuffs 176 outwardly extend from opposite sides 178 and 180 of the main panel 170. Each guide cuff 176 includes a central passage 182.

A liquid basin 184 is formed within the main panel 170. The liquid basin 184 is configured to receive liquid, such as coffee, and allow the liquid to pass out, such as into a carafe, through a drain 186.

A sensor recess 188 is also formed within the main panel 170. The sensor recess 188 is configured to receive a level sensor (not shown in FIG. 5), which is configured to detect a level of liquid within the carafe. Optionally, the carafe restraining plate 118 may not include the sensor recess. Also, optionally, the coffee making system 100 described herein may not include the level sensor.

Indentations 190 are also formed in the top surface 172 of the main panel 170. The indentations 190 are configured to receive and retain the arcuate ends 162 of the bearings 160 (shown in FIG. 4), as described herein. The carafe restraining plate 118 can include more or less indentations 190, depending on the number of bearings 160 of the axle 152 (shown in FIG. 4). Alternatively, the carafe restraining plate 118 may not include the indentations.

FIG. 6 illustrates an isometric front view of the carafe restraining plate 118 coupled to the first cartridge bracket 114 and the second cartridge bracket 116, according to an example of the present disclosure. The axle 152 is pivotally coupled to the first cartridge bracket 114 and the second cartridge bracket 116. Guide rods 192 extend through the passages 138, the guide cuffs 176, and onto the base tabs 132. The guide rods 192 are secured to the guide cuffs 176, such as via dowel pins, so that motion of the carafe restraining plate 118 is translated to motion of the guide rods 192. In at least one example, coil springs 196 can extend around ends of the guide rods 192 between the base tabs 132 and the guide cuffs 176, and are configured to exert a spring force into the carafe restraining plate 118 to bias the carafe restraining plate 118 upwardly toward the protuberances 136. Alternatively, coil springs may not be used.

As shown, the carafe restraining plate 118 may retain the level sensor 198. For example, the level sensors 198 can be retained within the sensor recess 188 (shown in FIG. 5).

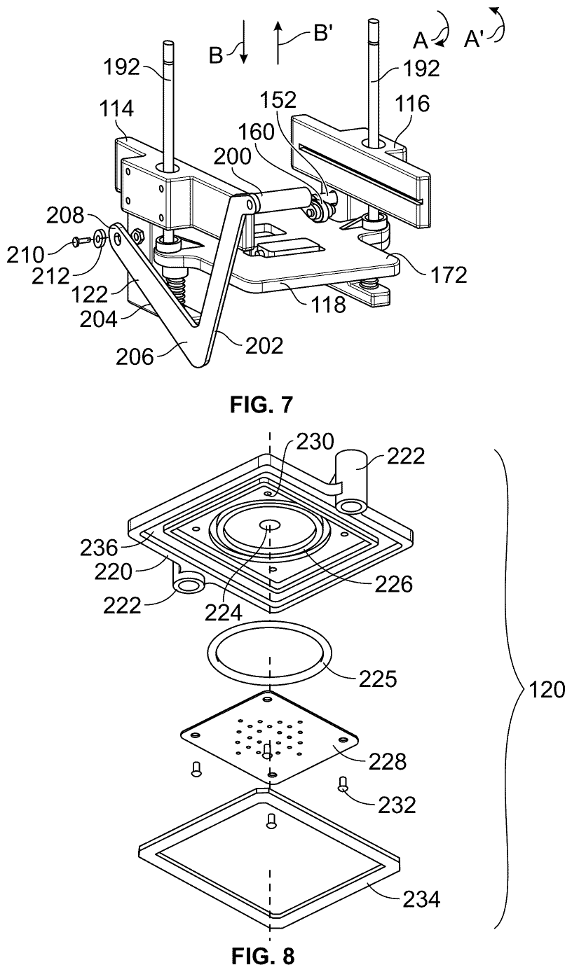

FIG. 7 illustrates an isometric front lateral view of the lever 122 coupled to the carafe restraining plate 118, according to an example of the present disclosure. The lever 122 includes a handle 200 inwardly extending from a first arm 202, which, in turn, connects to a second arm 204. The first arm 202 connects to the second arm 204 at an angle, such as between 45-90 degrees. As shown, the first arm 202 upwardly extends from a first end 206 the second arm 204. A second end 208 (opposite from the first end 206) of the second arm 204 directly connects to (or indirectly connects through a fastener, bearing, extension, and/or the like) to first end 156 of the axle 152 (shown in FIG. 4), such as via a fastener 210 (such as a screw or bolt), and a washer 212. Optionally, the second arm 204 can be integrally formed with the axle 152.

Referring to FIGS. 1-7, the bearings 160 seat on the top surface 172 of the carafe restraining plate 118. As the handle 200 of the lever 122 is grasped and pulled downwardly in the direction of arc A, the axle 152 (which is connected to the lever 122) rotates in the same direction, thereby forcing the carafe restraining plate 118 downwardly in the direction of arrow B. With continued movement of the lever 122 in the direction of arc A, the bearings 160 move into the indentations 190, which retain the bearings 160 therein. As such, the carafe restraining plate 118 is locked in place. During such motion and positioning, the springs 196 compress.

In order to move the carafe restraining plate 118 upwardly in the direction of arrow B′, the handle 200 is grasped and pulled upwardly in the direction of arc A′, which moves the bearings 160 out of the indentations 190. When the bearings 160 are moved out of the indentations 190, the carafe restraining plate 118 moves upwardly in the direction of arrow B′, such as can be further aided by the springs 196 decompressing.

FIG. 8 illustrates an isometric bottom exploded view of the shower head assembly 120, according to an example of the present disclosure. The shower head assembly 120 includes a main plate 220 having guide cuffs 222 outwardly extends from opposite sides of the main plate 220. A drain 224 is formed through the main plate 220. An O-ring 225 (such as formed of silicone) seats within a reciprocal channel 226 surrounding the drain 224. The O-ring 225 provides a sealing interface surrounding the drain 224. A head plate 228 is spaced apart from the drain 224 and secures within a recess 230 of the main plate 220 by one or more fasteners 232, such as screws or bolts. Liquid that passes out of the drain 224 flows through openings of (and/or around edges) the head plate 228. For example, the head plate 228 can be a mesh screen. It has been found that the head plate 228 provides a uniform distribution of hot water on to the coffee pillow pack within the pillow pack holding cartridge 124, which facilitates complete extraction of coffee grounds, and improves the taste of brewed coffee.

A gasket 234 is disposed within an outer channel 236 of the main plate 220 and provides an additional sealing interface therewith. The gasket 234 provides a leakproof seal between the shower head assembly 120 and the pillow pack holding cartridge 124 (shown in FIG. 2) during a coffee brewing operation. The O-ring 225 and the gasket 234 prevent water from undesirably leaking through portions of the shower head assembly 120 during the coffee brewing operation.

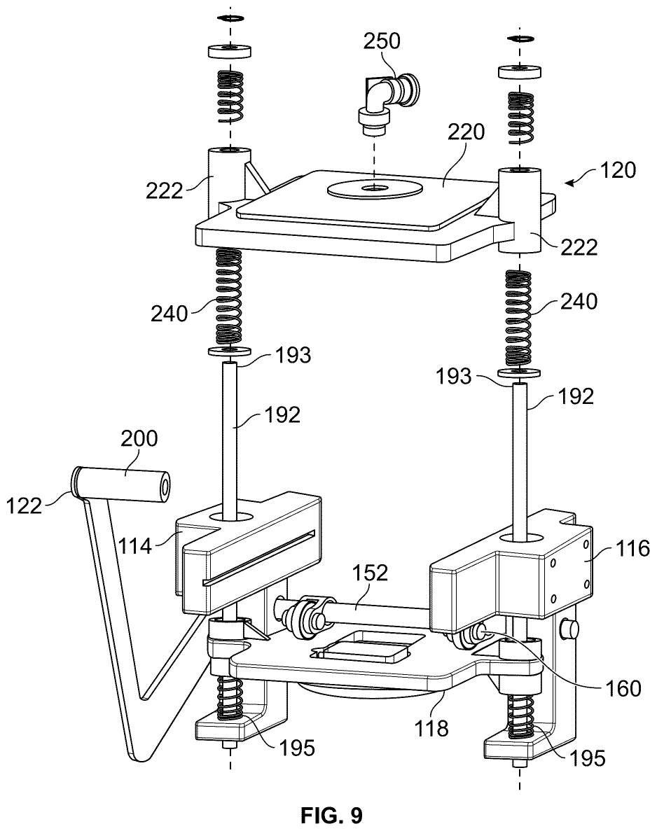

FIG. 9 illustrates an isometric front view of the shower head assembly 120 disconnected from guide rods 192, according to an example of the present disclosure. The guide rods 192 connect to the guide cuffs 222 of the shower head assembly 120. As shown, the shower head assembly 120 is secured to first ends 193 of the guide rods 192 (such as via dowel pins), while the carafe restraining plate 118 is secured to opposite second ends 195 of the guide rods 192 (such as via dowel pins). Coil springs 240 can also be disposed around portions of the guide rods 192 to provide a spring force between the first and second cartridge brackets 114 and 116 and the shower head assembly 120. The guide rods 192 couple the shower head assembly 120 to the carafe restraining plate 118. As such, movement of the carafe restraining plate 118 and the shower head assembly 120 is synchronized. When the lever 122 is operated to move the carafe restraining plate 118, the shower head assembly 120 moves in response to the motion of the carafe restraining plate 118.

As shown, an adaptor fitting 250 secures to the main plate 220, and is in fluid communication with the drain 224 (shown in FIG. 8) and a water source (not shown), such as a water reservoir, water supply line, and/or the like.

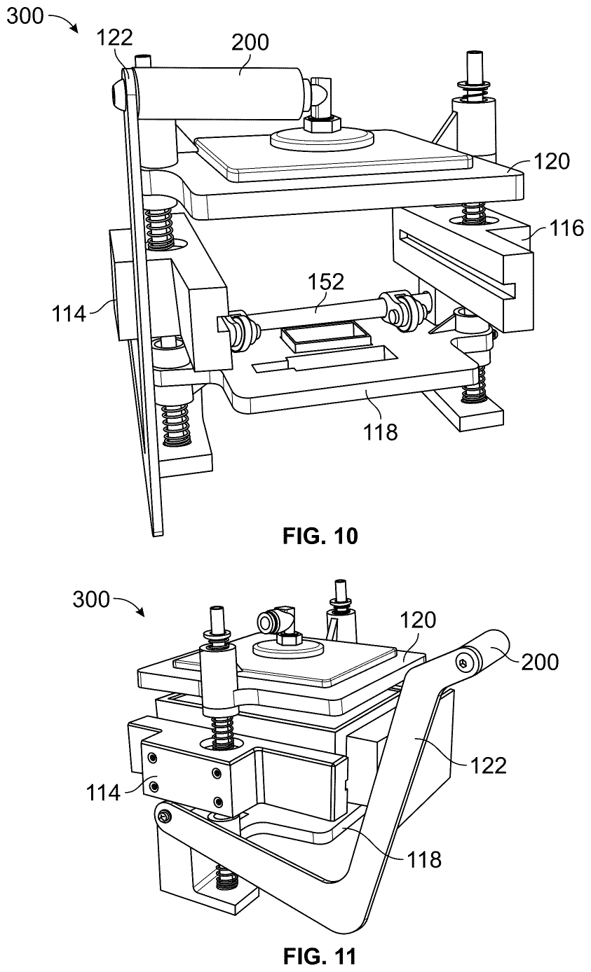

FIG. 10 illustrates a perspective front view of a system 300 for synchronizing the shower head assembly 120 with the carafe restraining plate 118, according to an example of the present disclosure. FIG. 11 illustrates a perspective side view of the system 300 of FIG. 10. Referring to FIGS. 1-11, the system 300 includes the lever 122 operatively coupled to the axle 152, which is operatively coupled to the carafe plate 118. The carafe retaining plate 118 is operatively coupled to the shower head assembly 120 through the guide rods 192.

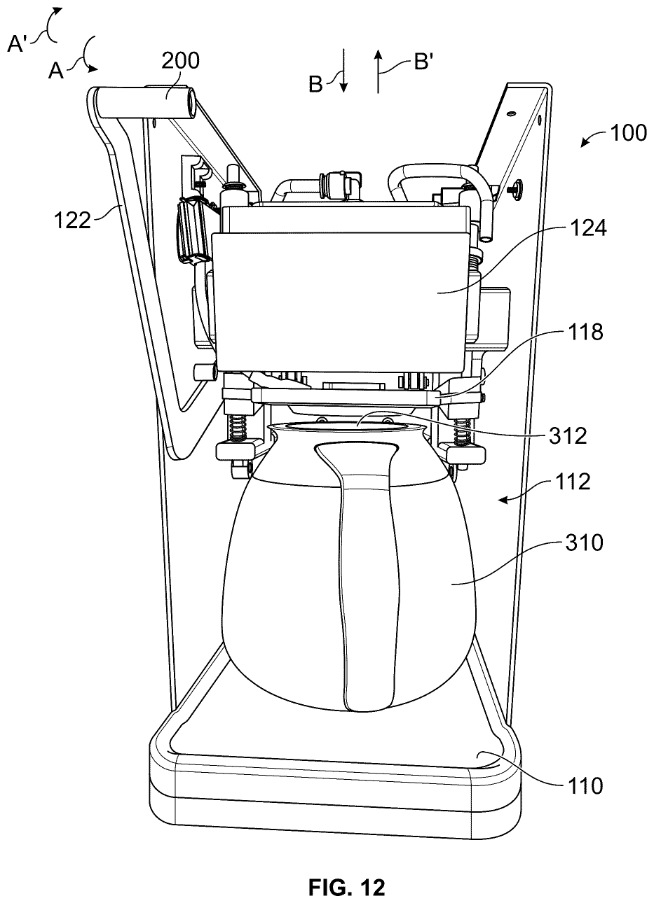

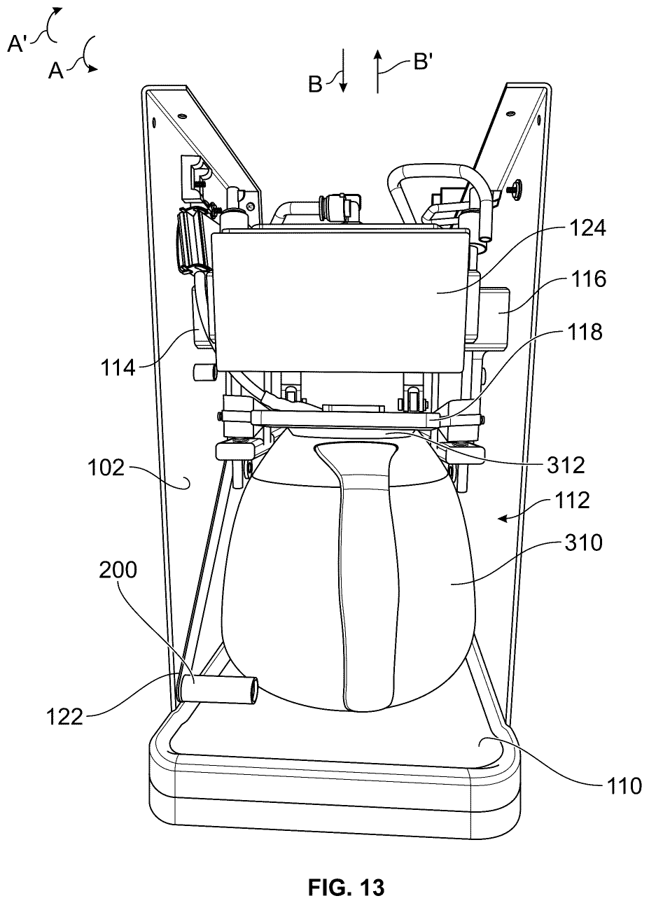

FIG. 12 illustrates a perspective front view of the coffee making system 100 supporting a carafe 310 in an unlocked position, according to an example of the present disclosure. FIG. 13 illustrates a perspective front view of the coffee making system 100 supporting the carafe 310 in a locked position, according to an example of the present disclosure. Referring to FIGS. 1-13, the base 110 supports the carafe 310 within the internal chamber 112.

As the lever 122 pivoted downwardly in the direction of arc A, the bearings 160 force the carafe restraining plate 118 downwardly onto a top 312 of the carafe 310, thereby providing a compressive, restraining force into the carafe 310. At the same time, the shower head assembly 120, which is coupled to the carafe restraining plate 118 through the guide rods 192, also moves in the same direction of arc A, while the pillow pack holding cartridge 124 remains fixed relative to the housing 102. Water can flow through the shower head assembly 120, through the pillow pack retained by the pillow pack holding cartridge 124 (thereby providing brewed coffee), out through the drain 186 of the carafe restraining plate 118, and into an open inlet of the top 312 of the carafe 310.

In order to remove the carafe restraining plate 118 from the carafe 310, the lever 122 is upwardly pivoted in the direction of arc A′, which causes the carafe restraining plate 118 to move upwardly in the direction of arrow B′ and unseat from the top of the carafe 310. In response, the shower head assembly 120 also moves upwardly in the direction of arrow B′, as the shower head assembly 120 is synchronously linked to the carafe restraining plate 118.

In at least one example, the bottom surface 174 of the carafe restraining plate 118 includes a gasket, which sealingly secures around a portion of the top 312 of the carafe 310, such as around an inlet of the top 312. As such, when the carafe restraining plate 118 is urged into the top 312 of the carafe 310, as described herein, the gasket prevents coffee or other liquid from leaking through the interface between the carafe restraining plate 118 and the carafe 310. The carafe restraining plate 118 is coupled to the shower head assembly 120 through the guide rods 192, which drives simultaneous, synchronized motion of the carafe restraining plate 118 and the shower head assembly 120 (as dictated by operation of the lever 122). Additionally, the pillow pack holding cartridge 124 can also include one or more gaskets which provide a sealing interface between the pillow pack holding cartridge 124 and one or both of the carafe restraining plate 118 and/or the shower head assembly 120.

As described herein, the system 300 provides a primary locking mechanism, which helps in synchronous locking the carafe 310 in place, as well as the pillow pack holding cartridge 124, with a single actuation (namely, moving of the lever 122, as described herein). Examples of the present disclosure eliminate, minimize, or otherwise reduce the need for a separate locking mechanism to lock the pillow pack holding cartridge 124 in place, as such is fixed to the housing 102 by the first cartridge bracket 114 and the second cartridge bracket 116.

Examples of the present disclosure provide the coffee making system 100, which has substantially less linkages, parts, and the like as compared to prior known coffee makers used in commercial aircraft, which thereby reduces overall weight and costs. Upon assembly of the system 300 as shown in FIGS. 10 and 11, the system 300 can be handled as a separate sub-system, and installed and/or removed from the coffee making system 100. Further, the system 300 can be easily assembled and disassembled without the use of specialized tools.

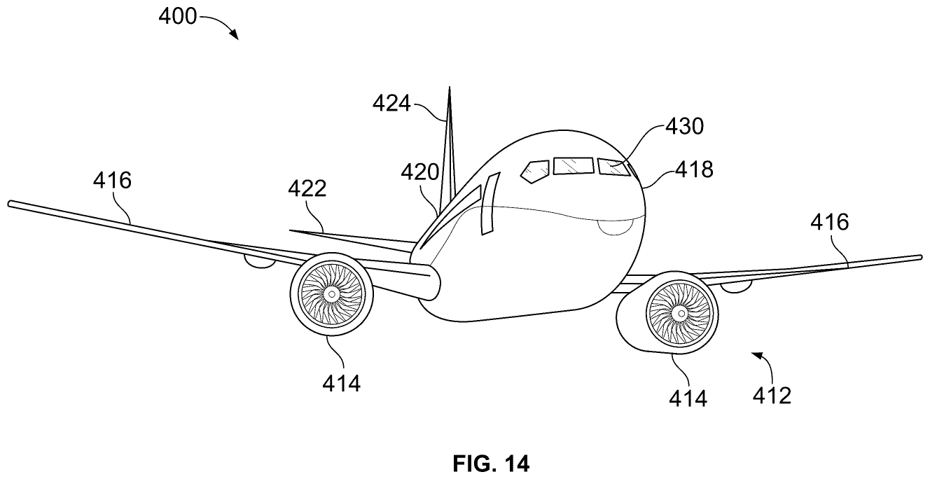

FIG. 14 illustrates a perspective front view of an aircraft 400, according to an example of the present disclosure. The aircraft 400 includes a propulsion system 412 that includes engines 414, for example. Optionally, the propulsion system 412 may include more engines 414 than shown. The engines 414 are carried by wings 416 of the aircraft 400. In other examples, the engines 414 may be carried by a fuselage 418 and/or an empennage 420. The empennage 420 may also support horizontal stabilizers 422 and a vertical stabilizer 424.

The fuselage 418 of the aircraft 400 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like.

Referring to FIGS. 1-14, the coffee making system 100 and methods described herein can be used within the internal cabin 430. For example, the coffee making system 100 can be disposed within a galley of the aircraft 400.

Further, the disclosure includes examples according to the following clauses:

Clause 1. A coffee making system comprising:
a housing;
a base coupled to the housing, wherein an internal chamber is defined between the housing and the base, wherein the internal chamber is configured to receive a carafe;
a carafe restraining plate;
a shower head assembly coupled to the carafe restraining plate; and
a lever operatively coupled to the carafe restraining plate, wherein movement of the lever causes synchronous motion of the carafe restraining plate and the shower head assembly.

Clause 2. The coffee making system of Clause 1, further comprising:
a first cartridge bracket secured to the housing; and
a second cartridge bracket secured to the housing,
wherein the first cartridge bracket and the second cartridge bracket are configured to removably retain a pillow pack holding cartridge.

Clause 3. The coffee making system of Clause 2, wherein each of the first cartridge bracket and the second cartridge bracket comprises a reciprocal groove configured to receive and retain a portion of the pillow pack holding cartridge.

Clause 4. The coffee making system of Clauses 2 or 3, wherein the first cartridge bracket and the second cartridge bracket are configured to fix the pillow pack holding cartridge in relation to the housing during the synchronous motion of the carafe restraining plate and the shower head assembly.

Clause 5. The coffee making system of any of Clauses 1-4, further comprising an axle having one or more bearings that engage the carafe restraining plate, wherein the axle is coupled to the lever.

Clause 6. The coffee making system of Clause 5, wherein the lever comprises:
a first arm;
a handle extending from the first arm; and
a second arm connected to the first arm, wherein the second arm operatively connects to the axle.

Clause 7. The coffee making system of Clauses 5 or 6, wherein the carafe restraining plate comprises one or more indentations configured to receive the one or more bearings to lock the carafe restraining plate and the shower head assembly in place.

Clause 8. The coffee making system of any of Clauses 1-7, wherein the carafe restraining plate comprises a liquid basin having a drain.

Clause 9. The coffee making system of any of Clauses 1-8, wherein the carafe restraining plate comprises a sensor recess configured to retain a level sensor.

Clause 10. The coffee making system of any of Clauses 1-9, further comprising one or more guide rods that couple the carafe restraining plate to the shower head assembly.

Clause 11. The coffee making system of Clause 10, further comprising one or more springs coupled to one or more of the one or more guide rods.

Clause 12. The coffee making system of any of Clauses 1-11, wherein the shower head assembly comprises:
a main plate, wherein a drain is formed through the main plate;
an O-ring secured to the main plate;
a head plate secured to the main plate; and
a gasket secured to the main plate.

Clause 13. A method for a coffee making system comprising:
a housing;
a base coupled to the housing, wherein an internal chamber is defined between the housing and the base,, wherein the internal chamber is configured to receive a carafe;
a carafe restraining plate;
a shower head assembly coupled to the carafe restraining plate; and
a lever operatively coupled to the carafe restraining plate,
the method comprising:
moving the lever; and
causing, by the moving of the lever, synchronous motion of the carafe restraining plate and the shower head assembly.

Clause 14. The method of Clause 13, further comprising removably retaining, by a first cartridge bracket and a second cartridge bracket, a pillow pack holding cartridge.

Clause 15. A coffee making system comprising:
a housing;
a base coupled to the housing, wherein an internal chamber is defined between the housing and the base, wherein the internal chamber is configured to receive a carafe;
a carafe restraining plate including one or more indentations;
a shower head assembly coupled to the carafe restraining plate;
one or more guide rods that couple the carafe restraining plate to the shower head assembly;
one or more springs coupled to one or more of the one or more guide rods;
a lever operatively coupled to the carafe restraining plate, wherein movement of the lever causes synchronous motion of the carafe restraining plate and the shower head assembly;
an axle having one or more bearings that engage the carafe restraining plate, wherein the axle is coupled to the lever, wherein one or more indentations are configured to receive the one or more bearings to lock the carafe restraining plate and the shower head assembly in place;
a first cartridge bracket secured to the housing; and
a second cartridge bracket secured to the housing,
wherein the first cartridge bracket and the second cartridge bracket are configured to removably retain a pillow pack holding cartridge, and wherein the first cartridge bracket and the second cartridge bracket are configured to fix the pillow pack holding cartridge in relation to the housing during the synchronous motion of the carafe restraining plate and the shower head assembly.

Clause 16. The coffee making system of Clause 15, wherein each of the first cartridge bracket and the second cartridge bracket comprises a reciprocal groove configured to receive and retain a portion of the pillow pack holding cartridge.

Clause 17. The coffee making system of Clauses 15 or 16, wherein the lever comprises:
a first arm;
a handle extending from the first arm; and
a second arm connected to the first arm, wherein the second arm operatively connects to the axle.

Clause 18. The coffee making system of any of Clauses 15-17, wherein the carafe restraining plate further comprises a liquid basin having a drain.

Clause 19. The coffee making system of any of Clauses 15-18, wherein the carafe restraining plate further comprises a sensor recess configured to retain a level sensor.

Clause 20. The coffee making system of any of Clauses 15-19, wherein the shower head assembly comprises:
a main plate, wherein a drain is formed through the main plate;
an O-ring secured to the main plate;
a head plate secured to the main plate; and
a gasket secured to the main plate.

As described herein, examples of the present disclosure provide an improved coffee making system, which can be used within an internal cabin of a vehicle, such as a commercial aircraft. Further, examples of the present disclosure provide an efficient, effective, and simple system and method for locking a pillow pack holder and a carafe in position during a brewing process.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A coffee making system comprising:
a housing;
a base coupled to the housing, wherein an internal chamber is defined between the housing and the base, wherein the internal chamber is configured to receive a carafe;
a carafe restraining plate;
a shower head assembly coupled to the carafe restraining plate; and
a lever operatively coupled to the carafe restraining plate, wherein movement of the lever causes synchronous motion of the carafe restraining plate and the shower head assembly.

2. The coffee making system of claim 1, further comprising:
a first cartridge bracket secured to the housing; and
a second cartridge bracket secured to the housing,
wherein the first cartridge bracket and the second cartridge bracket are configured to removably retain a pillow pack holding cartridge.

3. The coffee making system of claim 2, wherein each of the first cartridge bracket and the second cartridge bracket comprises a reciprocal groove configured to receive and retain a portion of the pillow pack holding cartridge.

4. The coffee making system of claim 2, wherein the first cartridge bracket and the second cartridge bracket are configured to fix the pillow pack holding cartridge in relation to the housing during the synchronous motion of the carafe restraining plate and the shower head assembly.

5. The coffee making system of claim 1, further comprising an axle having one or more bearings that engage the carafe restraining plate, wherein the axle is coupled to the lever.

6. The coffee making system of claim 5, wherein the lever comprises:
a first arm;
a handle extending from the first arm; and
a second arm connected to the first arm, wherein the second arm operatively connects to the axle.

7. The coffee making system of claim 5, wherein the carafe restraining plate comprises one or more indentations configured to receive the one or more bearings to lock the carafe restraining plate and the shower head assembly in place.

8. The coffee making system of claim 1, wherein the carafe restraining plate comprises a liquid basin having a drain.

9. The coffee making system of claim 1, wherein the carafe restraining plate comprises a sensor recess configured to retain a level sensor.

10. The coffee making system of claim 1, further comprising one or more guide rods that couple the carafe restraining plate to the shower head assembly.

11. The coffee making system of claim 10, further comprising one or more springs coupled to one or more of the one or more guide rods.

12. The coffee making system of claim 1, wherein the shower head assembly comprises:
a main plate, wherein a drain is formed through the main plate;
an O-ring secured to the main plate;
a head plate secured to the main plate; and
a gasket secured to the main plate.

13. A method for a coffee making system comprising:
a housing;
a base coupled to the housing, wherein an internal chamber is defined between the housing and the base,, wherein the internal chamber is configured to receive a carafe;
a carafe restraining plate;
a shower head assembly coupled to the carafe restraining plate; and
a lever operatively coupled to the carafe restraining plate,
the method comprising:
moving the lever; and
causing, by the moving of the lever, synchronous motion of the carafe restraining plate and the shower head assembly.

14. The method of claim 13, further comprising removably retaining, by a first cartridge bracket and a second cartridge bracket, a pillow pack holding cartridge.

15. A coffee making system comprising:
a housing;
a base coupled to the housing, wherein an internal chamber is defined between the housing and the base, wherein the internal chamber is configured to receive a carafe;
a carafe restraining plate including one or more indentations;
a shower head assembly coupled to the carafe restraining plate;
one or more guide rods that couple the carafe restraining plate to the shower head assembly;
one or more springs coupled to one or more of the one or more guide rods;
a lever operatively coupled to the carafe restraining plate, wherein movement of the lever causes synchronous motion of the carafe restraining plate and the shower head assembly;
an axle having one or more bearings that engage the carafe restraining plate, wherein the axle is coupled to the lever, wherein one or more indentations are configured to receive the one or more bearings to lock the carafe restraining plate and the shower head assembly in place;
a first cartridge bracket secured to the housing; and
a second cartridge bracket secured to the housing,
wherein the first cartridge bracket and the second cartridge bracket are configured to removably retain a pillow pack holding cartridge, and wherein the first cartridge bracket and the second cartridge bracket are configured to fix the pillow pack holding cartridge in relation to the housing during the synchronous motion of the carafe restraining plate and the shower head assembly.

16. The coffee making system of claim 15, wherein each of the first cartridge bracket and the second cartridge bracket comprises a reciprocal groove configured to receive and retain a portion of the pillow pack holding cartridge.

17. The coffee making system of claim 15, wherein the lever comprises:
a first arm;
a handle extending from the first arm; and
a second arm connected to the first arm, wherein the second arm operatively connects to the axle.

18. The coffee making system of claim 15, wherein the carafe restraining plate further comprises a liquid basin having a drain.

19. The coffee making system of claim 15, wherein the carafe restraining plate further comprises a sensor recess configured to retain a level sensor.

20. The coffee making system of claim 15, wherein the shower head assembly comprises:
a main plate, wherein a drain is formed through the main plate;
an O-ring secured to the main plate;
a head plate secured to the main plate; and
a gasket secured to the main plate.
